(19) United States
(12) Patent Application Publication
(10) Pub. No.: US 2026/0189647 A1
(43) Pub. Date: Jul. 2, 2026

(54) ACCESSORY MOUNT

(71) Applicant: PREMIER ACCESSORY GROUP LLC, Cranbury, NJ (US)

(72) Inventor: Alfred Esses, Brooklyn, NY (US)

(21) Appl. No.: 19/217,126

(22) Filed: May 23, 2025

Related U.S. Application Data
(60) Provisional application No. 63/740,204, filed on Dec. 30, 2024.

(51) Int. Cl. H04M 1/04; F16B 47/00; F16M 13/02

(52) U.S. Cl. CPC H04M 1/04; F16B 47/00; F16M 13/022; F16B 2200/83

(57) ABSTRACT

An accessory mount, and more specifically to a phone mount that is configured to secure the phone to the mount by both a magnetic connection and a vacuum or suction seal.

### CROSS-REFERENCE TO RELATED APPLICATION

This patent application claims benefit to U.S. Design patent application Ser. No. 29/943,703, filed May 23, 2024 and U.S. Provisional Patent Application No. 63/740,204 , filed Dec. 30, 2024, which are hereby incorporated by reference in their entirety as part of the present disclosure.

### FIELD OF THE INVENTION

The present disclosure generally relates generally to an accessory mount, and more specifically to a phone mount that is configured to secure the phone to the mount by both a magnetic connection and a vacuum or suction seal.

### BACKGROUND

In general, mounts for phones are well-known. However, no phone mount is configured to secure a phone thereto by both a magnetic connection and a vacuum or suction seal.

### SPECIFICATION

In an embodiment, the present disclosure is directed to a phone mount that is configured to secure a phone thereto by both a magnetic connection and a vacuum or suction seal.

In an embodiment, the phone mount generally includes a housing comprising a main body, a first cover plate fixable to the main body, a second cover plate that is configured to extend over the first cover plate and be fixable thereto, a magnetic ring fixed to and extending about the perimeter of the front surface of the main body, a suction cup or the like fixed to the main body and extending from the front of the main body, a vent fixed to the main body and protruding through the center of the suction cup, an O-ring seated within the main body, a cap extending over the O-ring and seated within the main body, a first release arranged between the first and second cover plates, a first spring arranged between the main body and cover plates and configured to interact with the first release, a second release arranged between the main body and cover plates, a second spring arranged between the main body and cover plates and configured to interact with the first arm, a third spring seated on the cap within the mount, and a plurality of fasteners.

In a first state or non-use state of the phone mount, the first spring applies a force in a first direction to the first release to be spaced from the cap and the second spring applies a force to the second release in a second direction that is opposite the first direction causing the second release to be spaced from the cap.

To secure a phone to the phone mount, the phone is placed against the phone mount creating a connection between the phone and the magnetic ring and the phone and the suction cup. The air inside of the suction cup is expelled when the phone is pressed against the suction cup, creating a vacuum seal inside of the suction cup which aids in preventing the phone from being disengaged from the phone mount. By forcing air out through the vent that in turn causes pressure to build in the cavity due to the arrangement of the O-ring, the cap and third spring within the housing creating a vacuum seal.

To release a phone or the like from the phone mount, a force is applied to the first release and/or the second release toward the center of the housing. The force can be applied to one of the first or second release or both of the first and second releases.

The force on the first release causes the first spring to be compressed and the groove and sloping surface of the groove of the first release to contact the lower surface of the body of the cap to cause the cap to be spaced from the O-ring which allows air that was trapped in the cavity of the cap to be released, breaking the air seal. This in turn causes the vacuum or suction seal to be released from the phone which is being held by the phone mount and in turn allows a user to separate the phone from the phone mount.

Similarly, when force on the second release causes the second spring to be compressed and the groove and sloping surface of the groove of the second release to contact the lower surface of the body of the cap to cause the cap to be spaced from the O-ring which allows air that was trapped in the cavity of the cap to be released, breaking the air seal. This in turn causes the vacuum or suction seal to be released from the phone which is being held by the phone mount and in turn allows a user to separate the phone from the phone mount.

If a force is applied to both the first and second release at the same time, it will cause the cap to be spaced away from the O-ring and main body to break the air seal. When the force is no longer applied to the first and/or second release, the first and second release will move away from the cap, allowing the cap to be seated or in contact with the main body and O-ring.

### BRIEF DESCRIPTION OF THE DRAWINGS

FIG. 1 is front perspective view of a phone mount according to an embodiment of the present disclosure;

FIG. 2 is rear perspective view of the phone mount according to an embodiment of the present disclosure;

FIG. 3 is a rear view of the phone mount according to an embodiment of the present disclosure;

FIG. 4 is a cross-sectional view of the phone mount according to an embodiment of the present disclosure;

FIG. 5 is an assembly view of the rear of the phone mount according to an embodiment of the present disclosure;

FIG. 6 is a perspective view of the rear side of the main body of the phone mount according to an embodiment of the present disclosure;

FIG. 7A is a front view of the phone mount according to an embodiment of the present disclosure with the suction cup removed;

FIG. 7B is a front view of the phone mount according to an embodiment of the present disclosure showing the magnets;

FIG. 8 is a top view of the cap of the phone mount according to an embodiment of the present disclosure;

FIG. 9 is a bottom view of the cap of the phone mount according to an embodiment of the present disclosure; and FIG. 10-12 are various views of the first release, the second release being identical to the first release.

### DETAILED DESCRIPTION OF EMBODIMENTS OF THE INVENTION

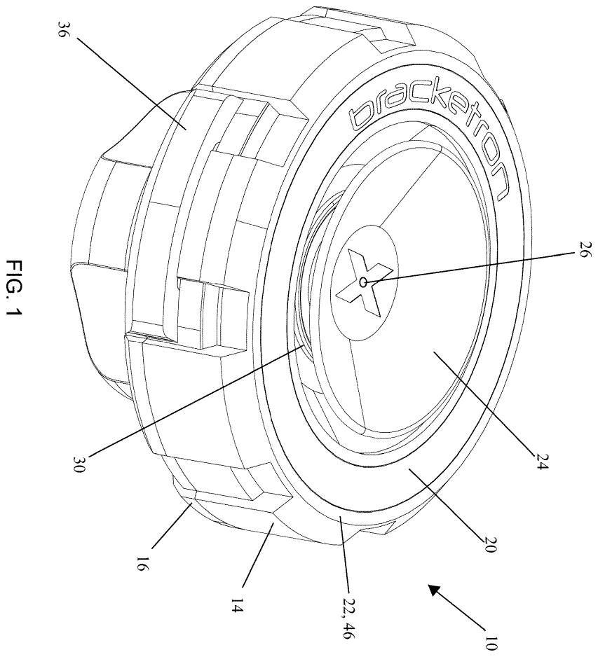

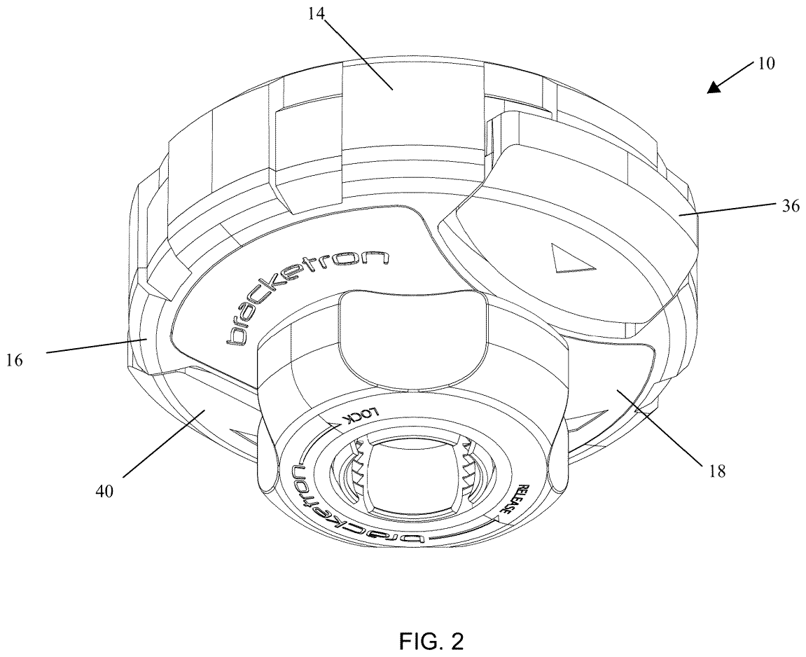

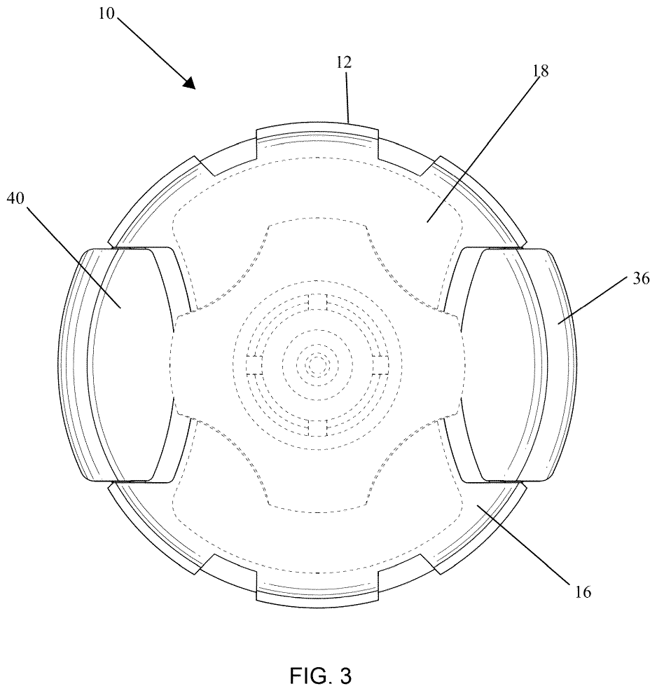

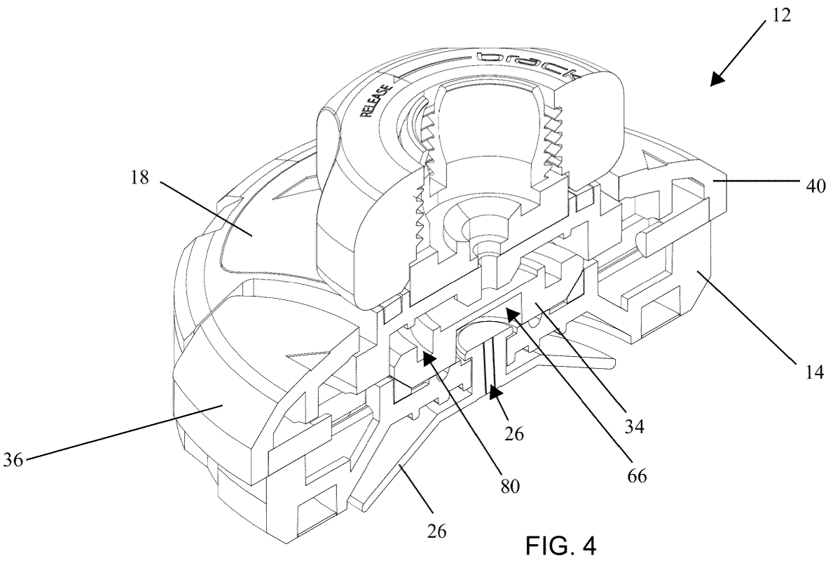

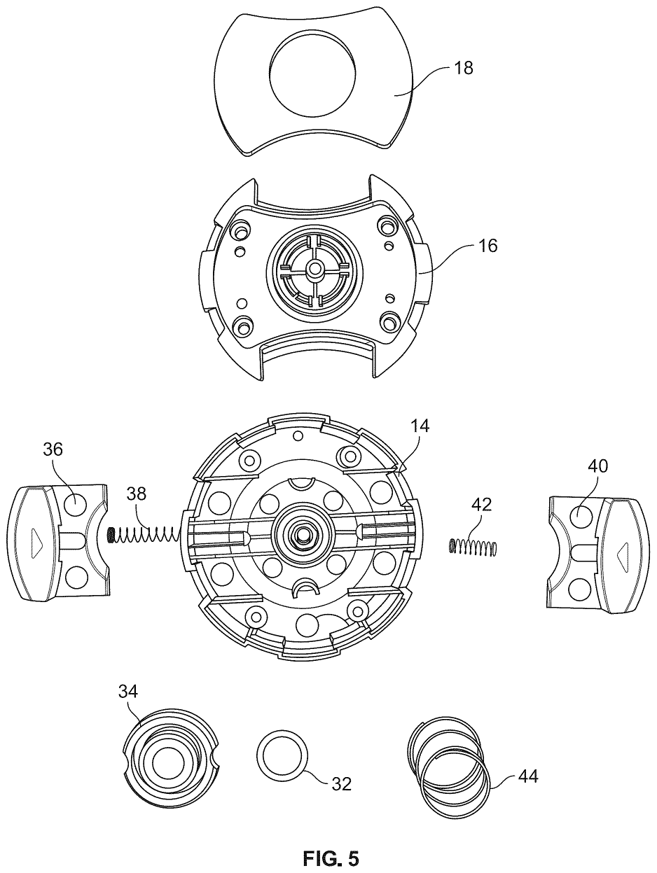

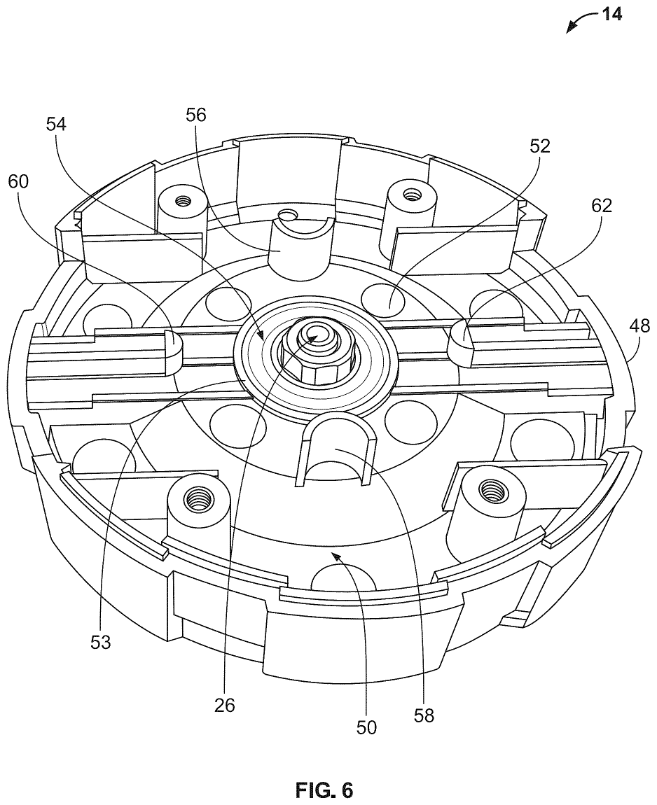

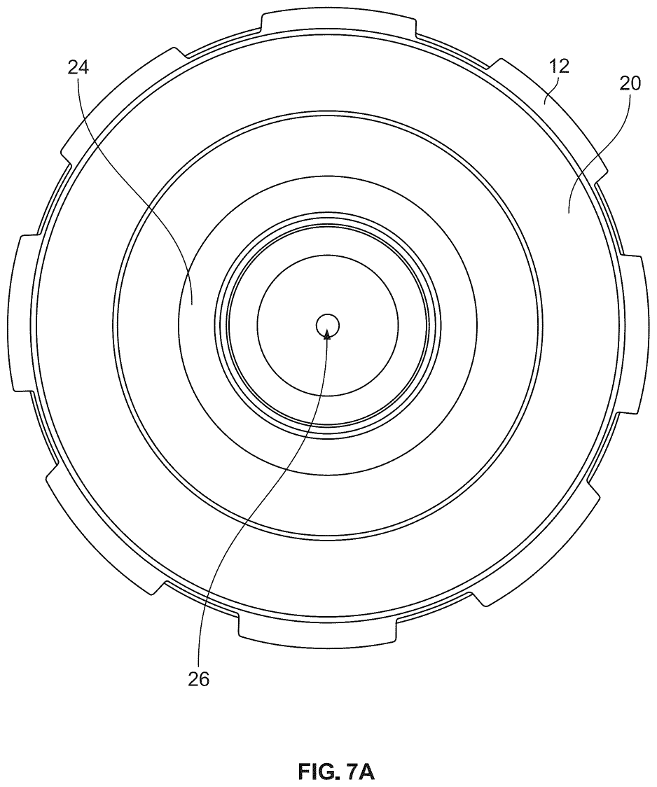

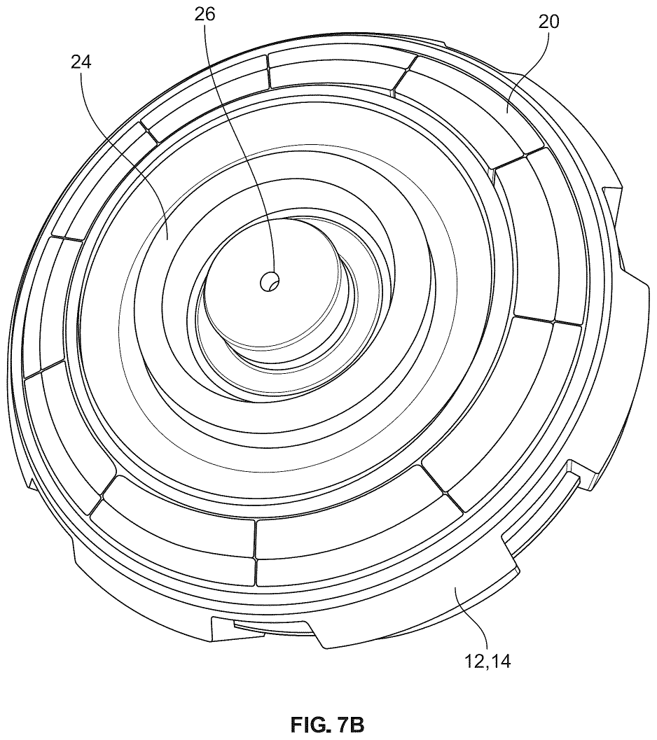

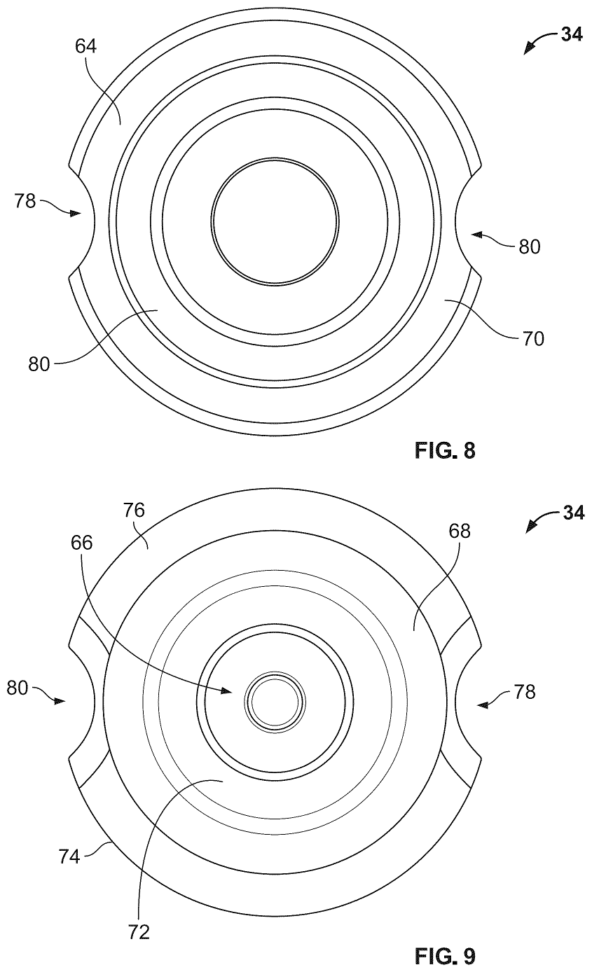

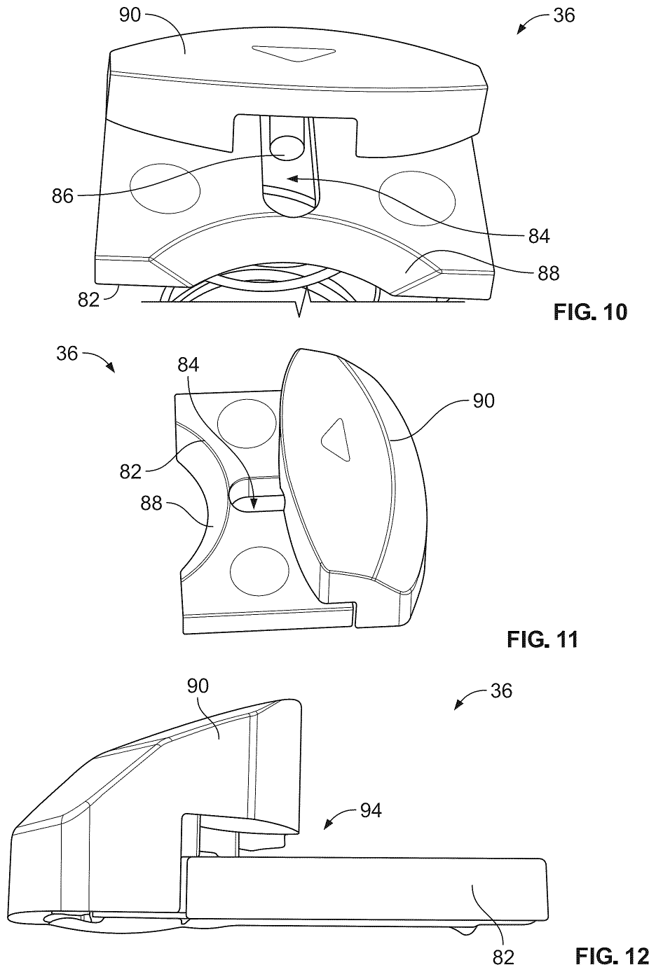

With reference now to the drawings and in particular FIGS. 1-12, embodiments of a phone mount of the present disclosure, which is generally designated by reference numeral 10.

As illustrated in FIGS. 1-12, the present disclosure is directed to a phone mount 10 that is configured to secure a phone thereto by both a magnetic connection and a vacuum or suction seal.

The phone mount 10 generally includes a housing 12 comprising a main body 14, a first cover plate 16 fixable to the main body 14, a second cover plate 18 that is configured to extend over the first cover plate 16 and be fixable thereto, a magnetic ring or a plurality of magnets 20 that is/are fixed to and extending about the perimeter of the front surface 22 of the main body 14, a suction cup or the like 24 (e.g., comprised of soft and elastic silicon or rubber) fixed to the main body 14 and extending from the front of the main body 14, a vent 26 fixed to the main body 14 and protruding through the center 28 of the suction cup 24, a grommet 30 (e.g., foam pad) that is fixed to the main body 14, extends therefrom and is contactable with the rear side of the suction cup 24, an O-ring 32 that is seated within the main body 14, a cap 34 that extends over the O-ring 32 and is seated within the main body 14, a first release 36 arranged between the first cover plate 16 and the second cover plate 18, a first spring 38 arranged between the main body 14 and the cover plates 16, 18 and configured to interact with the first release 36, a second release 40 arranged between the main body 14 and the cover plates 16, 18, a second spring 42 arranged between the main body 14 and cover plates 16, 18 and configured to interact with the second release 40, a third spring 44 seated on the cap 34, and a plurality of fasteners configured to secure select components of the phone mount 10.

The main body 14 includes a front side 46 and a rear side 48. The rear side 48 includes a cavity 50 in which a projection 52 extends from the center of the cavity 50. Sidewalls 53 extend from the projection 52 with a sloping circular depression 54 extending between the sidewalls 53 that is configured for the O-ring 32 to be arranged on the sloping circular depression 54 between the sidewalls 53. A first protrusion 56 and a second protrusion 58, which are spaced from each other and mirror opposite to each other, extend from the rear side 48 of the main body 14 and are configured to orientate the cap 34 and ensure that the cap in relation to the O-ring 32 and main body 14. A third protrusion 60 and a fourth protrusion 62, which are spaced from each other and mirror opposite to each other and which are each spaced from the first protrusion 56 and the second protrusion 58, extend from the projection 52. In an embodiment, the first protrusion 56 and the second protrusion 58 are spaced from each other by about 180 degrees and the third protrusion 60 and the fourth protrusion 62 are spaced from each other by about 180 degrees.

The cap 34 includes a substantially circular body 64 with a cavity 66 extending from a lower surface 68 of the body 64 of the cap 34 toward an upper surface 70 of the cap 34. A first sloping surface 72 extends from the cavity 66 within the cap 34 toward an outer periphery 74 of the cap 34 and a second sloping surface 76 extends from the outer periphery 74 of the cap 34 toward the upper surface 70. A first groove 78 and a second groove 80 extend from the outer periphery 74 of the cap 34 toward a center of the cap 34. The first groove 78 and the second groove 80 are shown as being mirror opposite each other. The upper surface 70 includes a circular depression 80 that is configured for the third spring 44 to be seated therein.

The first release 36 and the second release 40 each include a base 82 that has a first cutout 84 with a first projection 86 extending within the cutout 84 and a groove 88 extending inwardly from an outer periphery of the base 82. The groove 88 includes a sloping surface. An arm 90 extends from the base 82. The arm 90 includes a contoured sloping outer surface 92. A slot or gap 94 extends along the arm 92, spacing the arm 92, in part, from the base 82.

The cutout 84 of the first release 36 is arranged to extend over the third protrusion 60 of the main body 14 with the first spring 38 arranged at one end to extend over the projection 86 that extends within the cutout 84 of the first release 36 and a second end of the first spring 38 to be in contact with the third protrusion 60. The cutout 84 of the second release 40 is arranged to extend over the fourth protrusion 62 of the main body 14 with the second spring 42 arranged at one end to extend over the projection 86 that extends within the cutout 84 of the second release 40 and at a second end of the second spring 42 be in contact with the fourth protrusion 62.

In a first state or non-use state of the phone mount 10, the first spring 38 applies a force in a first direction to the first release 36 causing the cutout 84 to be in contact the third protrusion 60 of the main body 14 and the second spring 42 applies a force to the second release 40 in a second direction that is opposite the first direction in which the force is applied to the second release 40 causing the cutout 84 of the second release 40 to be in contact the fourth protrusion 62 of the main body 14.

To secure a phone to the phone mount 10, the phone is placed against the phone mount 10 creating a connection between the phone and the magnetic ring 20 and the phone and the suction cup 24. The air inside of the suction cup 24 is expelled when the phone is pressed against the suction cup 24, creating a vacuum seal inside of the suction cup which aids in preventing the phone from being disengaged from the phone mount 10. By forcing air out through the vent 26 that in turn causes pressure to build in the cavity 66 due to the arrangement of the O-ring 32, the cap 34 and third spring 44 within the housing 12 creating a vacuum seal.

To release a phone or the like from the phone mount 10, a force is applied to the first release 36 and/or the second release 40 toward the center of the housing 12. The force can be applied to one of the first or second release 36, 40 or both of the first and second releases 36, 40.

The force on the first release 36 causes the first spring 38 to be compressed and the groove 88 and sloping surface of the groove 88 of the first release 36 to contact the lower surface 68 of the body 64 of the cap 34 to cause the cap 34 to be spaced from the O-ring 32 which allows air that was trapped in the cavity 66 of the cap 34 to be released, breaking the air seal. This in turn causes the vacuum or suction seal to be released from the phone which is being held by the phone mount 10 and in turn allows a user to separate the phone from the phone mount 10.

Similarly, when force on the second release 40 causes the second spring 42 to be compressed and the groove 88 and sloping surface of the groove 88 of the second release 40 to contact the lower surface 68 of the body 64 of the cap 34 to cause the cap 34 to be spaced from the O-ring 32 which allows air that was trapped in the cavity 66 of the cap 34 to be released, breaking the air seal. This in turn causes the vacuum or suction seal to be released from the phone which is being held by the phone mount 10 and in turn allows a user to separate the phone from the phone mount 10.

If a force is applied to both the first and second release 36, 40 at the same time, it will cause the cap 34 to be spaced away from the O-ring 32 and main body 14 to break the air seal. When the force is no longer applied to the first and/or second release 36, 40, the first and second release 36, 40 will move away from the cap 34, allowing the cap 34 to be seated or in contact with the main body 14 and O-ring 32.

Although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. It is to be understood that the phraseology or terminology employed herein is for the purpose of description and not of limitation. In addition, while several variations of the embodiments of the invention have been shown and described in detail, other modifications, which are within the scope of this invention, including, but not limited to, the substitutions of equivalent features, materials, or parts, will be readily apparent to those of skill in the art based upon this disclosure without departing from the spirit and scope of the invention.

1. A phone mount, comprising:
a housing;
at least one magnet fixed to the housing;
a conical elastomeric member fixed to and extending from the housing;
a first release slidably fixed within the housing; and
a second release that is spaced from the first release and mirror opposite to the first release, slidably fixed within the housing.

2. (canceled)

3. The phone mount of claim 1, wherein the at least one magnet is a plurality of magnets arranged next to each other and extending about a circumference of the housing.

4. The phone mount of claim 1, further comprising a cap arranged within the housing, the cap having a cavity extending from a lower surface toward an upper surface, a sloping surface extending about the lower surface toward an outer periphery of the cap, a first groove and a second groove that is spaced from and mirror opposite the first groove with the first groove and the second groove extending from an outer periphery of the cap toward a center of the cap.

5. The phone mount of claim 1, further comprising a vent extending through the conical elastomeric member.

6. The phone mount of claim 1, wherein the first release and the second release each include a base that is delimited along a first side, a second side, a third side and a fourth side of thereof with a cutout extending through the base, a projection extending within the cutout, a groove extending inwardly from the first side of the base and an arm extending upwardly from the third side of the base.

7. The phone mount of claim 6, further comprising a first spring extending at one end over the projection of the first release and in contact with the housing at a second end of the first spring and a second spring extending at one end over the projection of the second release and in contact with the housing at a second end of the second spring.

8. The phone mount of claim 1, further comprising a cover plate that is fixable to the housing.

9. The phone mount of claim 4, further comprising a third spring that is arranged between the housing and cover plate and in contact with the cap.

10. The phone mount of claim 1, wherein, when a phone is placed in contact with the with the phone mount, a connection is created between the phone and the at least one magnet and the conical elastomeric member, preventing the phone from being disengaged from the phone mount.

11. The phone mount of claim 1, wherein, to release the phone from the phone mount, a force is applied to at least one of the first release and the second release toward the center of the housing causing the groove of at least one of the first release and the second release to contact the lower surface of the cap and at least in part, lifting the cap to break the seal formed between the phone and conical elastomeric member.

12. A method of securing and releasing a device to a phone mount, comprising the steps of:
providing a phone mounting comprising a housing, at least one magnet fixed to the housing, a conical elastomeric member fixed to and extending from the housing, a cap and a first release slidably fixed within the housing and a second release that is spaced from the first release and mirror opposite to the first release, slidably fixed within the housing;
to secure the phone to the phone mount, placing the device against the housing creating a magnetic connection between the device and the phone mount and creating a seal between the device and the phone mount; and
to release the phone from the phone mount, applying a force to at least one of the first release and the second release in a direction toward the center of the housing causing at least one of the first release and the second release to contact the cap and at least in part, lift the cap to break the seal formed between the phone and conical elastomeric member.

13. The method of claim 12, wherein when the cap is lifted, air retained between the cap and housing escapes through an opening that extends through the conical elastomeric member.
